(19) United States
(12) Patent Application Publication
(10) Pub. No.: US 2008/0289441 A1
(43) Pub. Date: Nov. 27, 2008

(54) Gear Wheel with Damping Element

(76) Inventors: Joachim Schadow, Leinfelden-Echterdingen (DE); Juergen Wiker, Hangzhou/Bing Jiang District (CN)

Correspondence Address: MICHAEL J. STRIKER, 103 EAST NECK ROAD, HUNTINGTON, NY, 11743, US

(21) Appl. No.: 12/094,657

(22) PCT Filed: Aug. 1, 2007
(86) PCT No.: PCT/EP07/57949

§ 371 Date: May 22, 2008

(30) Foreign Application Priority Data
Sep. 21, 2006 (DE) 10 2006 044 446.9

(51) Int. Cl. F16H 55/20; F16H 55/02

(52) U.S. Cl. 74/459.5; 475/344

(57) ABSTRACT

The invention relates to a toothed wheel of a gear drive, particularly for electric hand machine tools, comprising a toothing and a damping element made of an elastic material, the element being disposed in a recess of the toothed wheel. The object of the invention is to improve the effectiveness and the operational safety of the damping element on a toothed wheel with little effort in order to increase the service life of the gear drive. The task is solved by the toothed wheel (1) having a recess (5) penetrating the toothing (2).

### RELATED ART

The present invention relates to a gear wheel of a gear drive, in particular for electrical hand-held power tools, with a toothing and a damping element composed of an elastic material that is located in a recess of the gear wheel.

Due to manufacturing costs, sintered gear wheels are typically used with gear drives in electrical hand-held power tools. The gear drive composed of sintered gear wheels in particular has large manufacturing-related tolerances, in particular pitch errors, profile deviations, and concentricity flaws, which result in unavoidable tooth play and generate considerable running noises and vibrations. Due to the tooth play, the start-up forces that act when the hand-held power tools are switched on, and the peak loads that occur during operation result in high mechanical loads on the toothing. All in all, the tooth play has a negative effect on the service life of the gear drive. To compensate for the tooth play, damping elements composed of an elastic material are therefore located in the drive train of the transmission, as described in DE 102 59 519 A1. Damping elements located directly on the gear wheel that extend past the contour of the toothing in regions are also known.

Publication GB 2 224 805 A describes a tooth washer with an elastic insert fitted into an edge recess of the spur gear. The circumferential profile of the tooth washer corresponds with the profile of the gear wheel, but the tooth washer extends beyond the outer contour of the toothing of the spur gear. The force components that act on the gear wheel during operation of the gear drive may generate mechanical loads in the tooth washer, which could cause the tooth washer to detach from the gear wheel. The embodiment made known in EP 0 641 957 attempts to counter this disadvantage by providing that a partial section of the gear wheel is formed by a toothed ring made of a resilient material with a partially raised toothed profile that is located on a projection of the gear wheel and is held securely in its position by inwardly projecting strips that engage in the toothing of the projection. The risk of the toothed ring becoming detached is further reduced by the fact that the toothed ring includes an annular flange on the side facing away from the gear wheel, the annular flange bearing against a further gear wheel that is seated securely on the projection of the first gear wheel. The design used to prevent detachment of the elastic damping element is technically very complex, however.

In addition, the damping elements, which are located exclusively on the edge of the gear wheel per the related art, result in an unfavorable distribution of forces and tensions in the gear drive, which may result—disadvantageously—in the gear drive becoming prematurely worn.

The object of the present invention is to improve the efficacy and operational reliability of the damping element on a gear wheel with little outlay, in order to increase the service life of the gear drive.

### DISCLOSURE OF THE INVENTION

The object is attained in that the gear wheel includes a recess that penetrates the toothing.

While, with recesses according to the related art, the damping element bears only against the toothing, with an inventive recess that penetrates the toothing, the damping element is enclosed—at least partially—by the toothing. As a result, and due solely to its being at least partially enclosed by the toothing, the damping element placed in the recess is provided with lateral support transversely to the direction of the compressive force that the mating gear wheel exerts on the gear wheel and the damping element. The risk that the damping element will become detached laterally is greatly reduced as a result, thereby increasing the service life of the damping element and enabling it to more effectively perform its advantageous damping functions on the gear wheel.

Due to the measures listed in the subclaims, advantageous refinements and improvements of the inventive gear wheel described in claim 1 are made possible.

Assuming that the toothing has a contour, and according to a preferred embodiment, the recess penetrates this contour such that an opening enclosed by the contour is formed. As a result, a particularly secure hold results on all sides of the damping element, which is enclosed by the unresilient edges of the opening formed by the contour of the toothing made of hard material, while the teeth of the mating gear wheel roll off of the contour of the toothing. The risk that the damping element will become detached laterally from the toothed wheel transversely to the direction of the compressive force of the mating gear wheel is basically eliminated.

Another result is that the damping element is integrated centrally in the toothing of the gearwheel, thereby preventing uneven loads on the gear drive due to the overhang of the damping element in the edge position of the gear wheel, thereby further increasing the service life of the gear drive.

It is advantageous when the recess is covered by the tooth crown. The recess therefore penetrates the toothing such that a weakening of the gear wheel in the region of the teeth—in particular of the tooth crest—is prevented, thereby preventing premature breakage of the teeth. The stability of the damping element embedded in the recess is also increased.

In an advantageous embodiment, the damping element has a profile that is flush with the contour of the toothing. By being embedded in the toothing, the damping element—even without extending beyond the tooth profile—already has damping properties, since the toothing is hereby provided with an elasticity that may compensate for the profile deviations and concentricity flaws of meshing gear wheels.

This also prevents wear—which is to be expected during prolonged operation of the gear drive—of the damping element that extends beyond the tooth profile, and even prevents the profile overhang from being sheared off, particularly in the region of the tooth crown.

The damping elements, which have a profile that extends beyond the contour of the toothing, also result in effective damping of the gear drive, because the overhanging profile of the inventive, enclosed damping element also receives support.

Good damping results, in particular, when the profile of the damping element terminates above a tooth base. The tooth base, which corresponds to the diameter of the base circle of a spur gear, for example, is the height of the toothing up to which—when the gear wheel pair is engaged—the toothing of the mating gear wheel enters the toothing of the gear wheel. The forces of gear wheels rolling against each other—which are to be damped—are therefore transferred mainly in this region. If the profile of the damping element extends past this toothing base, the damping element touches the teeth of the mating gear wheel, thereby effectively damping the action of the mating gear wheel as it rolls off of the gear wheel.

In a preferred embodiment, the recess is designed as an annular groove with repeating openings in the contour of the tooth gap and the adjacent tooth flanks, an annular damping element being located in the recess. The design of this annular groove with the associated annular damping element is easy to manufacture and results in a stable, non-detachable positioning of the damping element with effective damping properties.

In an alternative embodiment, the recess is designed as a bore with an opening in the contour of the tooth gap and/or the tooth flank, a pin-shaped damping element being located in the recess. The recess does not penetrate the toothing as a continuous groove, but only partially, thereby preventing the gear wheel from becoming weakened, particularly in the case of small gear wheels.

### BRIEF DESCRIPTION OF THE DRAWING

The inventive gear wheel is described in greater detail below with reference to various exemplary embodiments, which are depicted schematically in the associated drawing.

FIG. 1 shows a top view of a crown wheel of a bevel gear drive with an annular groove and an annular damping element,

FIG. 2 shows a cross-sectional illustration of the crown wheel along the line of intersection A-A in FIG. 1,

FIG. 3 shows an enlarged, perspective view of the toothing in detail area X in FIG. 1,

FIG. 4 shows a further cross-sectional illustration of the crown wheel along the line of intersection A-A in FIG. 1, with a positional variation of the annular groove and the annular damping element,

FIG. 5 shows an enlarged, perspective detailed view of the toothing with tooth grooves and tooth-shaped damping elements, and

FIG. 6 shows an enlarged cross section of the toothing in detail, with bore holes and pin-shaped damping elements.

### EMBODIMENT(S) OF THE INVENTION

The crown wheel presented in a special embodiment in FIGS. 1 through 6 is a component of a bevel gear drive that is preferably used in electrical hand-held power tools. Independently of the embodiment of the gear drive shown in this example, the present invention may also be used with other gear drives, e.g., with a spur gear drive or a worm gear drive.

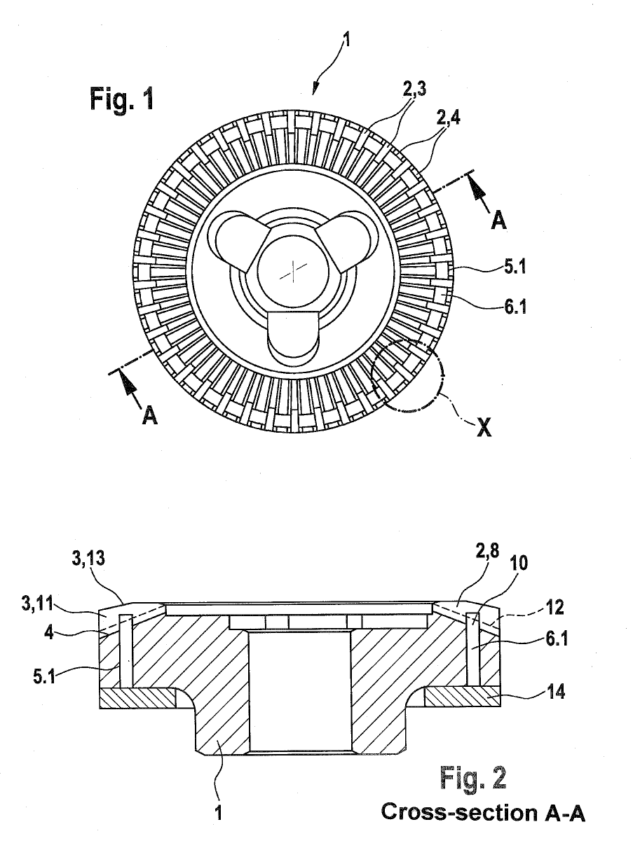

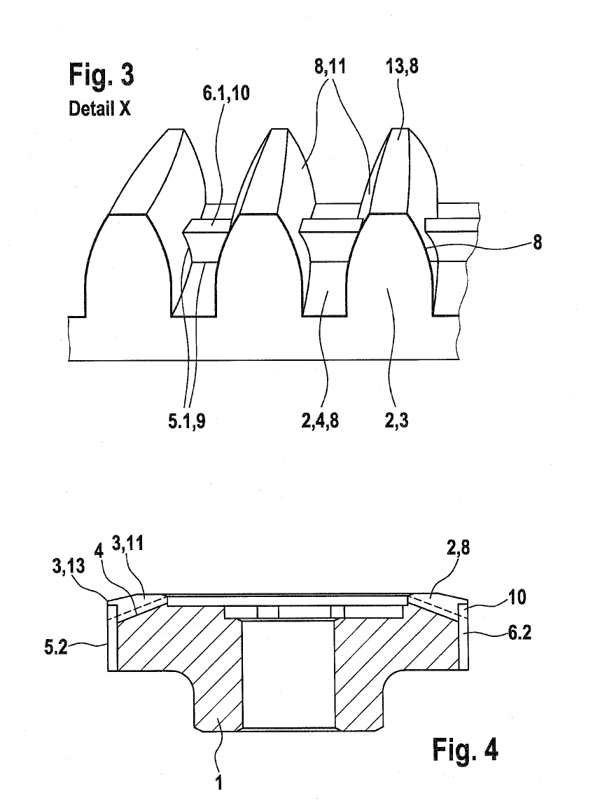

FIG. 1 shows a top view of crown wheel 1 of the bevel gear drive. Neither the bevel gear—as the drive pinion for crown wheel 1—associated with the gear wheel pair of the bevel gear drive, nor the associated gear shafts are shown, for simplicity. Crown wheel 1, which is composed, e.g., of sintered material, has a toothing 2 on its edge that is composed of alternating rows of teeth 3 and tooth gaps 4, which are evenly spaced. Toothing 2 is penetrated by a recess 5 in the form of an integrated annular groove 5.1. Annular groove 5.1 may be formed in crown wheel 1 using a single machining step. An elastic damping element 6, which is designed as damping ring 6.1 and is made, e.g., of hard rubber, is embedded in annular groove 5.1, and it is fixable in position in annular groove 5.1 via bonding, for example. The position of annular groove 5.1 and damping ring 6.1 in toothing 2 is shown clearly in FIG. 2. Annular groove 5.1 results in repeating openings 9 in contour 8 of toothing 2, through which profile 10 of damping ring 6.1 extends, as shown clearly in FIG. 3. Openings 9 are bounded by contour 8 of a tooth gap 4 and contours 8 of tooth flanks 11 adjacent to tooth gap 4. Profile 10 of damping ring 6.1 extends past contour 8 of tooth gap 4 and tooth flanks 11. Profile 10 of overhanging damping ring 6.1 terminates above tooth base 12 (shown as a dashed line in FIG. 2) of crown wheel 1, so that, when the not-shown bevel gear engages with crown wheel 1, damping ring 6.1 comes in contact with the tooth crowns of this bevel gear, thereby damping the bevel gear drive. Annular groove 5.1 is formed in toothing 2 only so deep that it is ensured that annular groove 5.1 is covered by tooth crowns 13 of crown wheel 1 to an extent that is adequate for the stability of gear wheel 1. Damping ring 6.1 is secured against radial displacement or detachment from crown wheel 1 by the fact that it is embedded in opening 9 of toothing 2.

FIG. 2 also shows a retaining ring 14 on the underside of crown wheel 1, which also fixes damping ring 6.1 in position axially relative to crown wheel 1 in annular groove 5.1 during operation of the bevel gear drive, therefore increasing the stability of damping ring 6.1 in crown wheel 1 against the acting compressive force of the bevel gear. Retaining ring 14 may be attached to crown wheel 1, e.g., via a screwed connection, staking, or bonding.

To adapt to various damping requirements, the width, height, and diameter of annular groove 5.1 may be selected as necessary depending on the adapted dimensions of damping ring 6.1 in terms of its width, height, and diameter. FIG. 4 shows, e.g., an annular groove 5.2 located on the outer diameter of crown wheel 1 with a damping ring 6.2 that has a larger diameter. In this case as well, primarily in order to support damping ring 6.2 in annular groove 5.2, annular groove 5.2 is formed in toothing 2 only so deep that it is ensured that annular groove 5.2 and damping ring 6.2 are covered by tooth crowns 13 of crown wheel 1.

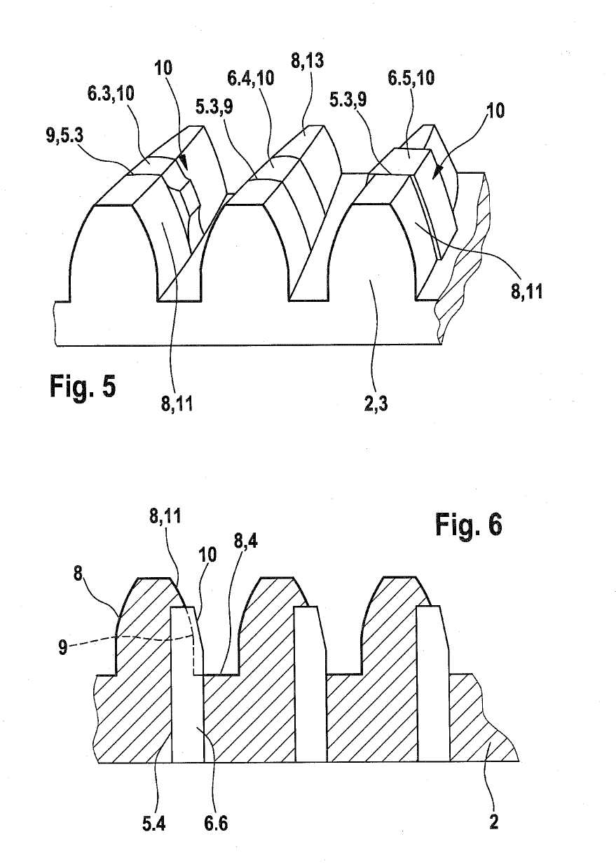

FIG. 5 shows repeating recesses 5 in the form of tooth grooves 5.3 in teeth 3 of toothing 2. Tooth grooves 5.3 may be manufactured individually or in a standardized manner in a single machining step. Various tooth-shaped damping elements 6.3, 6.4, 6.5 are located in tooth grooves 5.3, for example. Damping element 6.3 has a nub-shaped profile 10 that extends beyond contour 8 of tooth flank 11. Damping element 6.4 has a profile 10 that is completely flush with contour 8 of tooth flank 11 and tooth crown 13. Profile 10 of damping element 6.5 extends beyond—with its entire surface area—contour 8 of dual-sided tooth flank 11 of tooth 3.

FIG. 6 shows, in a cross-sectional portion of toothing 2, repeating recesses 5 as bores 5.4, each with an opening 9 in contour 8 of a tooth gap 4 and a tooth flank 11. A pin-shaped damping element 6.6. is located in bore 5.4 and extends—via its profile 10—past contour 8 of tooth gap 4 and tooth flank 11. This design of recesses 5 reduces the cross-sectional weakening of crown wheel 1 to a minimum, while also providing good damping results, and is therefore particularly well-suited for use with small crown wheels 1 with a low material concentration.

Recesses 5 in toothing 2 may also be provided in various numbers and combinations, depending on the particular application and damping requirements. Of course, the hardness of the elastic material of damping element 6 may be varied in any of the exemplary embodiments described above, in order to adapt to the particular damping requirements.

Beyond the exemplary embodiments shown, and depending on the particular damping requirements, further geometric designs of recess 5 that penetrates through toothing 2, and of associated damping element 6 are possible, which also result in the advantages described above.

What is claimed is:

1. A gear wheel of a gear drive, in particular for electrical hand-held power tools, with toothing and a damping element composed of an elastic material, the damping element being located in a recess of the gear wheel,
wherein
the gear wheel (1) includes a recess (5) that penetrates the toothing (2).

2. The gear wheel as recited in claim 1,
wherein
the toothing (2) has a contour (8) that is penetrated by the recess (5) such that an opening (9) enclosed by the contour (8) is formed.

3. The gear wheel as recited in claim 1,
wherein
the contour (8) of the toothing (2) is formed by the surface of tooth gaps (4), tooth flanks (11), and tooth crowns (13).

4. The gear wheel as recited in claim 1,
wherein
the opening (9) is enclosed by the contour (8) of a tooth gap (4), a tooth flank (11), and/or a tooth crown (13).

5. The gear wheel as recited in claim 1,
wherein
the recess (5) is located such that it is covered by tooth crown (13).

6. The gear wheel as recited in claim 1,
wherein
the damping element (6) has a profile (10) that is flush with the contour (8) of the toothing (2).

7. The gear wheel as recited in one of the preceding claims claim 1,
wherein
the profile (10) of the damping element (6) is flush with the contour (8) of the tooth crown (13).

8. The gear wheel as recited in claim 1,
wherein
the damping element (6) has a profile (10) that extends past the contour (8) of the toothing (2).

9. The gear wheel as recited in claim 1,
wherein
the profile (10) of the damping element (6) terminates above the toothing base (12).

10. The gear wheel as recited in claim 1,
wherein
the recess (5) is designed as an annular groove (5.1) with repeating openings (9) in the contour (8) of the tooth gap (4) and the adjacent tooth flanks (11), an annular damping element (6.1) being located in the annular groove (5.1).

11. The gear wheel as recited in claim 1,
wherein
the recess (5) is designed as a bore (5.4) with an opening (9) in the contour (8) of the tooth gap (4) and/or the tooth flank (11), a pin-shaped damping element (6.6) being located in the bore (5.4).

12. The gear wheel as recited in claim 1,
wherein
the gear wheel (1) is a crown wheel of a bevel gear drive.

13. The gear wheel as recited in claim 1,
wherein
the crown wheel (1) includes a retaining ring (14) for fixing the damping element (6) in position.
